(19) United States
(12) Patent Application Publication
(10) Pub. No.: US 2008/0238918 A1
(43) Pub. Date: Oct. 2, 2008

(54) VIEW-SPECIFIC REPRESENTATION OF REINFORCEMENT

(75) Inventors: Timothy D. Culver, Waltham, MA (US); Erik Michael Snell, Arlington, MA (US)

Correspondence Address: FISH & RICHARDSON P.C., PO BOX 1022, MINNEAPOLIS, MN, 55440-1022, US

(73) Assignee: AUTODESK, INC., San Rafael, CA (US)

(21) Appl. No.: 11/695,535

(22) Filed: Apr. 2, 2007

(51) Int. Cl. G06T 17/00

(52) U.S. Cl. 345/420

(57) ABSTRACT

Methods, systems, and apparatus, including computer program products, for representing reinforcement. A three-dimensional (3D) solid object in a computer aided design (CAD) model is identified. The solid object has a volume. A reinforcement element is associated with the solid object. The reinforcement element defines a path within the volume, occupies no space in the volume, and has a width value greater than zero. The reinforcement element is rendered as a ribbon having a width and having no volume. The width of the ribbon is the width value of the reinforcement element. A view of the solid object, including a view of the ribbon, is presented. The width of the ribbon is orthogonal to a direction of the view of the solid object.

### BACKGROUND

This specification relates to computer aided design.

Computer aided design (CAD) software tools are commonly used to prepare a CAD model or models representing a structure, such as a building. A CAD model can incorporate representations of physical elements, such as columns, beams, slabs, walls, and the like that will be included in the structure. Drawings prepared from such a model can be used in the actual physical construction of the corresponding structure. The CAD model may be prepared and edited by various individuals, including architects and structural engineers.

In the typical design of concrete floor slabs and walls there is a need to incorporate into the CAD model a large number of physical reinforcement elements such as steel reinforcing bars (“rebar”) which serve to strengthen the concrete. Some CAD tools represent reinforcement elements as fully modeled three-dimensional (3D) solid objects. While this allows for accurate renderings in plan and cut views, typical CAD models of buildings will require the representation of tens of thousands of reinforcement elements. This complexity creates tremendous computational overhead in the manipulation of a CAD model since the surface of a single reinforcement bar is typically represented in a CAD model as a mesh of polygons.

### SUMMARY

In general, one aspect of the subject matter described in this specification can be embodied in methods that include the actions of identifying a three-dimensional (3D) solid object in a computer aided design (CAD) model, where the solid object has a volume; associating a reinforcement element with the solid object, where the reinforcement element defines a path within the volume, occupies no space in the volume, and has a width value greater than zero; rendering the reinforcement element as a ribbon having a width and having no volume, where the width of the ribbon is the width value of the reinforcement element; and presenting a view of the solid object, including a view of the ribbon, where the width of the ribbon is orthogonal to a direction of the view of the solid object. Other embodiments of this aspect include corresponding systems, apparatus, and computer program products.

Particular embodiments of the subject matter described in this specification can be implemented to realize one or more of the following advantages. Reinforcement elements (e.g., rebar) are represented in a CAD model without requiring them to be rendered as fully three-dimensional objects, thus improving the rendering speed for views of the CAD model that contain reinforcement elements. Additionally, the size of a CAD model is reduced since solid objects are not used to represent reinforcement elements in the CAD model. The thickness of reinforcement elements (e.g., the diameter of a rebar) is visually apparent in a rendering of the reinforcement elements. Interference between reinforcement elements and other CAD model objects can be performed by visual inspection of a rendering of the reinforcement elements. Arrangements of reinforcement elements can be calculated by external analysis applications and automatically imported into the CAD model.

The details of one or more embodiments of the of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 illustrates a three-dimensional view of a computer-aided design (CAD) model of a physical structure.

FIGS. 2A and 2B illustrate a section view of a column in the physical structure.

FIG. 3 is a flow diagram illustrating an example process for representing reinforcement elements in a solid object.

FIGS. 4A and 4B illustrate a section view of a beam in the physical structure.

FIG. 5 illustrates an elevation view of the physical structure.

FIGS. 6A and 6B illustrate a structural plan view of the physical structure.

FIG. 7 is a block diagram of an example system as might be implemented by a CAD tool.

FIG. 8 is a schematic diagram of a generic computer system.

Like reference numbers and designations in the various drawings indicate like elements.

### DETAILED DESCRIPTION

A CAD model can be created using an interactive CAD tool, for example, or a CAD model can be obtained from one or more files, object-oriented databases, relational databases, distributed objects, combinations of these, or other suitable storage. In some implementations, the CAD tool is Autodesk® Revit® Structure, available from Autodesk, Inc. of San Rafael, Calif. A CAD model can incorporate one or more physical elements (e.g., floor slab, wall, column, beam, or other elements) of one or more physical structures (e.g., a building) as solid objects. Multiple physical elements can be combined to form a complex solid object. For example, a column and a beam can be combined to form a complex solid object modeling a beam framed into a column. A plurality of properties can be associated with each solid object that can detail the location and geometry of the solid object, the manner of connectivity of the solid object to other solid objects, materials used to realize the solid object (e.g., concrete, wood, steel), geometry of any openings in the solid object (e.g., windows, doors, stairways, or heating and ventilation ducts), and other suitable properties.

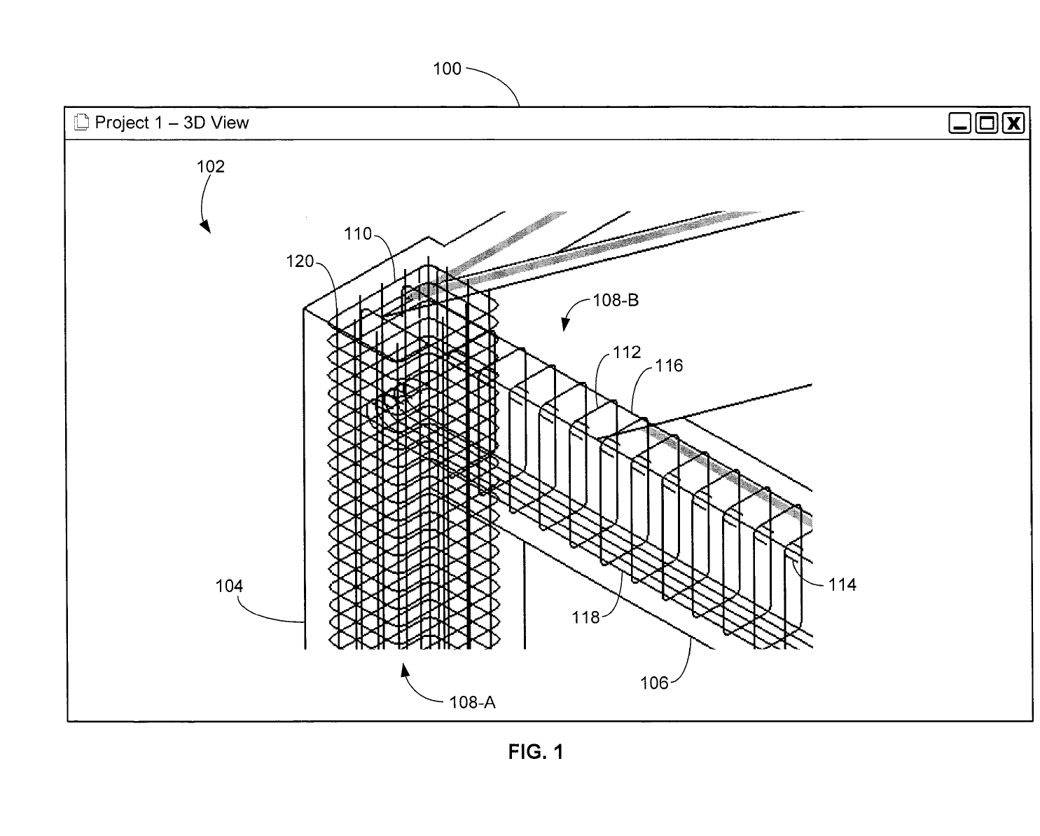

FIG. 1 shows a 3D view 100 of a portion of a CAD model that includes one or more solid objects. The view 100 can be presented by an interactive CAD software tool that allows users to interactively view, create, import, export, manipulate, and modify one or more CAD models. More than one view of a CAD model can be presented simultaneously. Although the view 100 presents an isometric view of a structure 102, other views are possible, such as a plan view, a section view, an elevation view, an orthographic projection, a diametric projection, a trimetric projection, a oblique projection, combinations of these, or other views. The view 100 reveals, among other things, a column object 104 and a beam object 106 that are defined as solid objects in the CAD model.

The CAD model can also include representations of one or more reinforcement elements, which for sake of brevity will be referred to hereinafter as reinforcement elements. An example of a reinforcement element is rebar. By way of illustration, the view 100 shows renderings of reinforcement elements in the structure 102. For example, the column object 104 includes column reinforcement elements that are rendered as rebar 108-A (e.g., rebars 110, 120), and the beam object 106 includes beam reinforcement elements that are rendered as rebar 108-B (e.g., rebars 112, 114, 116, 118). In some implementations, reinforcement elements are represented in the CAD model as 3D line objects having no volume.

A reinforcement element can have any of a variety of configurations in the volume of a solid object (e.g., a floor slab or a wall). For example, in the view 100, the rebar 108-A and 108-B are shown as having several configurations within the volume of column 104 and beam 106, respectively. An example of a configuration of a reinforcement element is a simple straight line configuration, an example of which is rebar 120. Other, more complex configurations are possible. Examples of more complex configurations include a round-cornered rectangular configuration (e.g., rebars 110, 112), a horseshoe-like configuration (e.g., rebar 114), and a straight line with either or both ends bent or hooked (e.g., rebars 116, 118).

A configuration of a reinforcement element defines a 3D path within the volume of a solid object along which the reinforcement element is considered to be located. For example, a reinforcement element with a simple straight line configuration (e.g., rebar 120) defines a straight line path through the volume of a solid object. As another example, a reinforcement element with a round-cornered rectangular configuration (e.g., rebars 110, 112) defines a closed, round-cornered rectangular path through the volume of a solid object. As a further example, a reinforcement element with a horseshoe-like configuration (e.g., rebar 114) defines an open path that resembles a letter “U” or a horseshoe.

Any number of properties can be associated with a reinforcement element. A reinforcement element can be associated with a shape or geometry. In some implementations, a reinforcement element is associated with a substantially cylindrical geometry (e.g., a sweep of a circular shape). For example, a rebar is generally cylindrical, but may have grip-enhancing deformations (e.g., ridges). In some other implementations, a reinforcement element is associated with a prism geometry (e.g., a sweep of a polygonal shape).

A reinforcement element is associated with a width value. For example, the width value of a reinforcement element that is associated with a cylindrical geometry (e.g., a rebar) is a diameter value of the reinforcement element. In some implementations, the diameter value is the nominal diameter of the reinforcement element. The nominal diameter of a reinforcement element is the diameter of the reinforcement element absent any grip-enhancing deformations (e.g., ridges) to the reinforcement element. In some other implementations, the diameter value of the reinforcement element is the diameter of the reinforcement element, including any grip-enhancing deformations.

As an illustration, a No. 3 rebar is defined by a standards body as having a nominal diameter of 0.375 inches. A representation of a No. 3 rebar has a width value of 0.375 inches, which is the nominal diameter of the No. 3 rebar.

A reinforcement element has an axis. The axis of a reinforcement element runs through the center of the reinforcement element. For example, if the reinforcement element is associated with a substantially cylindrical geometry, the axis runs through the center of the cylindrical geometry, intersecting with the diameter line of the cylindrical geometry. The axis runs along the entire length of the reinforcement element and follows the configuration of the reinforcement element. Thus, for example, if a rebar representation has a round-cornered rectangular configuration, the axis of the rebar representation also has a round-cornered rectangular configuration. In some implementations, when a reinforcement element is rendered and presented as a 3D line in the 3D view 100, the 3D line is aligned with the axis of the reinforcement element. That is, the 3D line represents the axis of the reinforcement element.

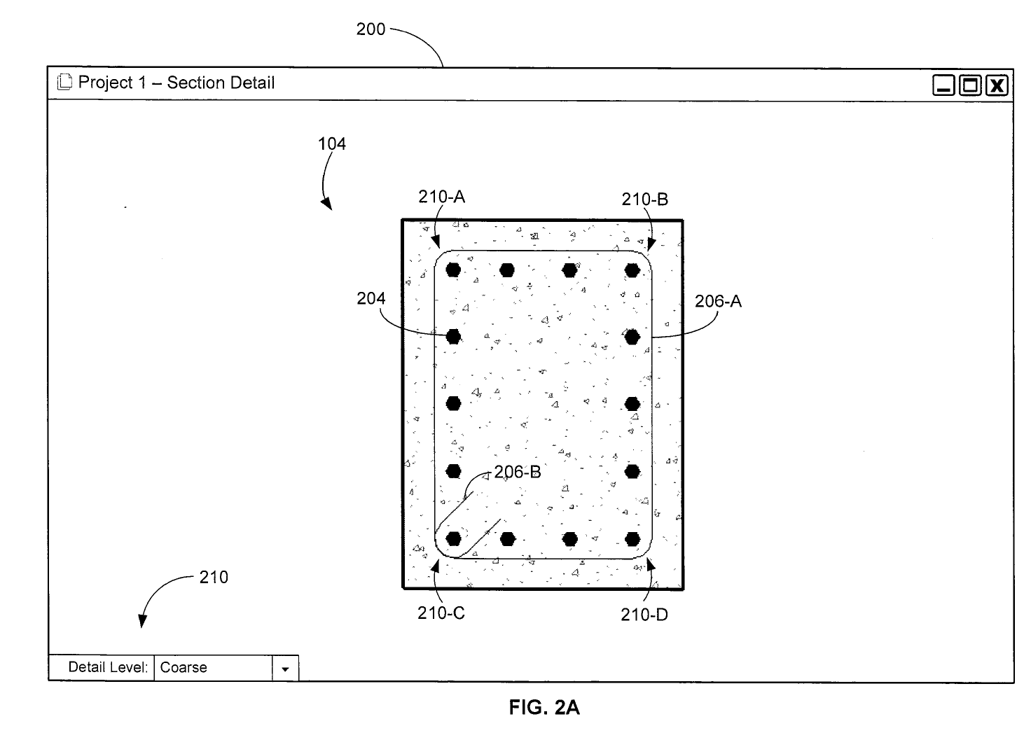

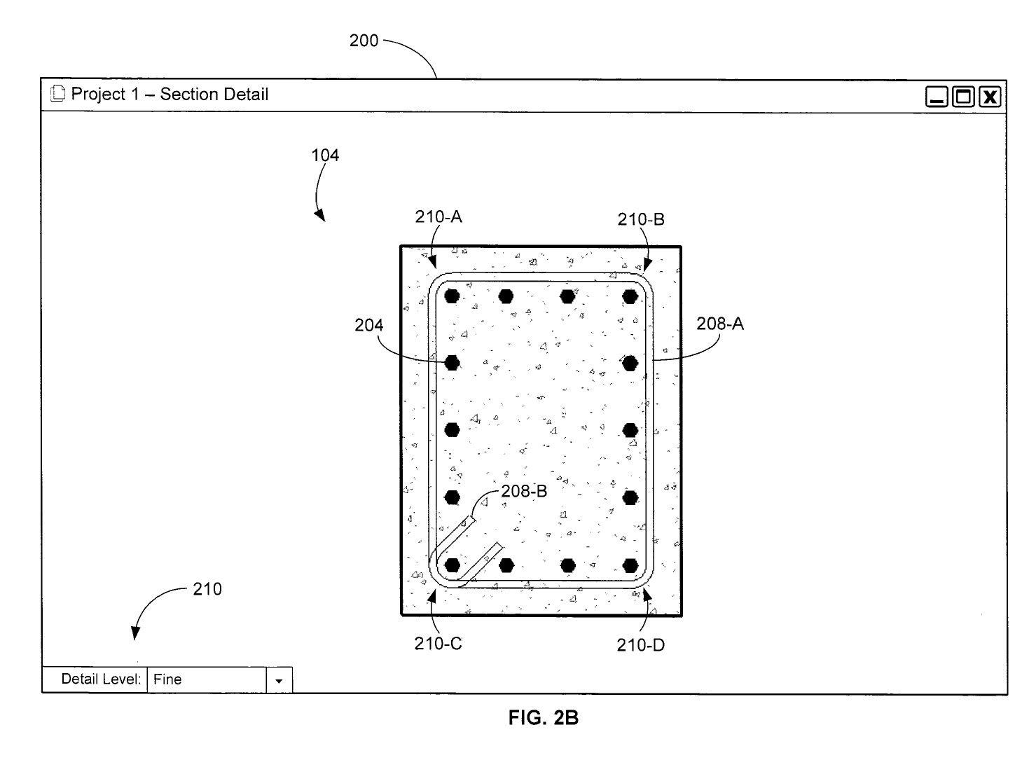

Two-dimensional (2D) views of one or more solid objects in a CAD model can be rendered and presented by the interactive CAD software tool. In some implementations, the 2D view that is rendered and presented is a section view, an elevation view, or a plan view. FIGS. 2A and 2B show a section view 200 of column object 104. The section view 200 shows a cross-section of the column object 104 at an intersection of the column object with a cross-sectional plane. In FIGS. 2A and 2B, the direction of the section view 200 is orthogonal to the cross-sectional plane. The section view 200 also presents renderings of cross-sections of reinforcement elements 206-A and 206-B. The reinforcement elements 206-A and 206-B run orthogonal to the direction of the section view 200 and run parallel to the cross-sectional plane. The section view 200 also reveals a cross-section of a reinforcement element 204 that runs parallel to the direction of the section view 200 and runs orthogonal to the cross-sectional plane. The cross-sections of the reinforcement elements 206-A and 206-B can be rendered and presented in section view 200 as lines corresponding to the axes of the reinforcement element representations 206-A and 206-B, respectively.

In some implementations, the section view 200 includes a user-settable detail level option 210. When the detail level option 210 is set to a “coarse” or an otherwise relatively low detail level, the reinforcement elements 206-A and 206-B are rendered as 2D, as illustrated in FIG. 2A, for example. The detail level option 210 can be implemented in a user interface of the interactive CAD software tool as a pull-down menu, one or more buttons, or one or more radio buttons, for example.

A reinforcement element can be rendered as a ribbon. A “ribbon” resembles a flat strip and has a length, a width, but no height. Ribbons trace reinforcement element paths and can be rendered for presentation in 2D views (e.g., section view, elevation view, plan view). A ribbon is rendered such that the width dimension of the ribbon is orthogonal to the direction of the view. The ribbon may include any curves, hooks, or the like in the configuration of the corresponding reinforcement element, even if the curves or hooks are not visually apparent in the view in which the ribbon is presented.

In various implementations, the width of a ribbon is the width value of the corresponding reinforcement element. For example, in a view that shows a cross-section of a reinforcement element that is orthogonal to the direction of the view, the width of the corresponding reinforcement element ribbon is equal to the width value of the reinforcement element, regardless of the location of the intersection of the cross-sectional plane with the reinforcement element. For a cylindrical reinforcement element, the width of a reinforcement element ribbon representing the cylindrical reinforcement element is the diameter value of the reinforcement element, even if the cross-sectional plane intersects the reinforcement element off-center or at an angle. In a view that shows a projection of a reinforcement element, the width of the ribbon representing the reinforcement element is the width value of the reinforcement element.

In some implementations, when the detail level option 210 in section view 200 is set to a “fine” or an otherwise relatively high detail level, the cross-sections of the reinforcement elements 206-A, 206-B are presented as views of ribbons 208-A, 208-B. In the section view 200, the flat faces of the ribbons 208-A, 208-B are orthogonal to the direction of the view.

The axes of the ribbons 208-A and 208-B are aligned with the respective axes of reinforcement elements 206-A and 206-B, respectively. That is, the ribbon is centered along the axis of the corresponding reinforcement element.

In FIGS. 2A and 2B, reinforcement element 206-A and corresponding ribbon 208-A has a round-cornered rectangular configuration, with rounded corners 210-A, 210-B, 210-C, and 210-D. Reinforcement element 206-B and corresponding ribbon 208-B has a horseshoe configuration.

It should be appreciated, however, that the rendering and presentation of the reinforcement elements as ribbons in response to a change in a detail level option is merely exemplary. Other ways of activating such rendering and presentation is possible. For example, the rendering and presentation of the reinforcement elements as ribbons may be a default mode whenever a 2D view of a solid object having reinforcement elements is rendered and presented.

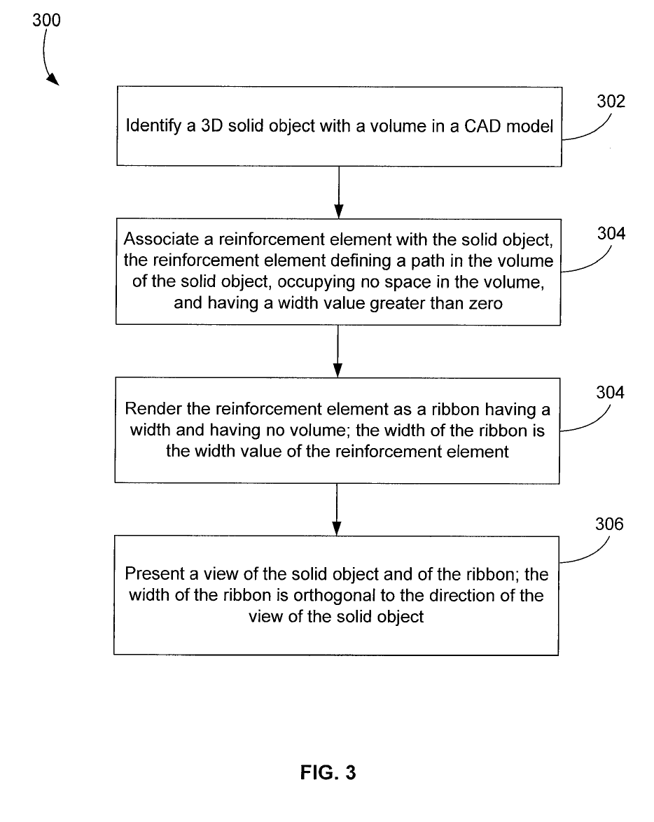

FIG. 3 is a flow diagram illustrating an example process 300 for representing reinforcements elements in a solid object. A 3D solid object in a CAD model is identified (302). The CAD model can be a model of a structure, and the 3D solid object can represent one or more physical elements of the structure. For example, the 3D solid object can be a floor slab, column, or beam, or combinations of physical elements, for example. The 3D solid object can be modeled in a CAD tool. The 3D solid object has a volume.

A reinforcement element is associated with the solid object (304). The reinforcement element can be added to the solid object in the CAD model manually by a user or automatically by the CAD tool.

The reinforcement element defines a path of the reinforcement element within the volume of the 3D solid object. The reinforcement element can be associated with one or more properties, including a width value that is greater than zero. The reinforcement element occupies no space within the volume of the solid object.

The reinforcement element is rendered as a ribbon having a width and having no volume (306). The width of the ribbon is the width value of the reinforcement element. The ribbon can be rendered for presentation in a two-dimensional (2D) view of the solid object. In some implementations, the 2D view is a section view, a plan view, or an elevation view. The ribbon is rendered such that the width dimension of the ribbon is orthogonal to the direction of the 2D view. A view of the solid object, including a view of the ribbon, is presented (308). The width dimension of the ribbon is orthogonal to the direction of the view of the solid object.

In some implementations, rendering a reinforcement element as a ribbon includes taking the configuration or path of the reinforcement element, the width value of the reinforcement element, and the view direction as inputs. The output is a ribbon, the face or surface of which is orthogonal to the direction of the view.

In some implementations, a reinforcement element ribbon is rendered on the fly as a lightweight 3D geometry with no volume, and with a length and a width, but no height or an indefinitely small height parallel to the direction of the view (i.e., no thickness or indefinitely small thickness parallel to the direction of the view).

In some implementations, the rendering and presenting of the reinforcement element as a ribbon occurs in response to a request to show a 2D view of the solid object or a change, in the 2D view, in a detail level setting of the view to a “fine” or an otherwise relatively high level.

In some implementations, the view of the ribbon can represent a cross-section of the corresponding reinforcement element or a projection of the reinforcement element onto a viewing plane. In some implementations, the view of the ribbon is the projection of the ribbon onto the viewing plane. In some implementations, the projection is an orthographic projection.

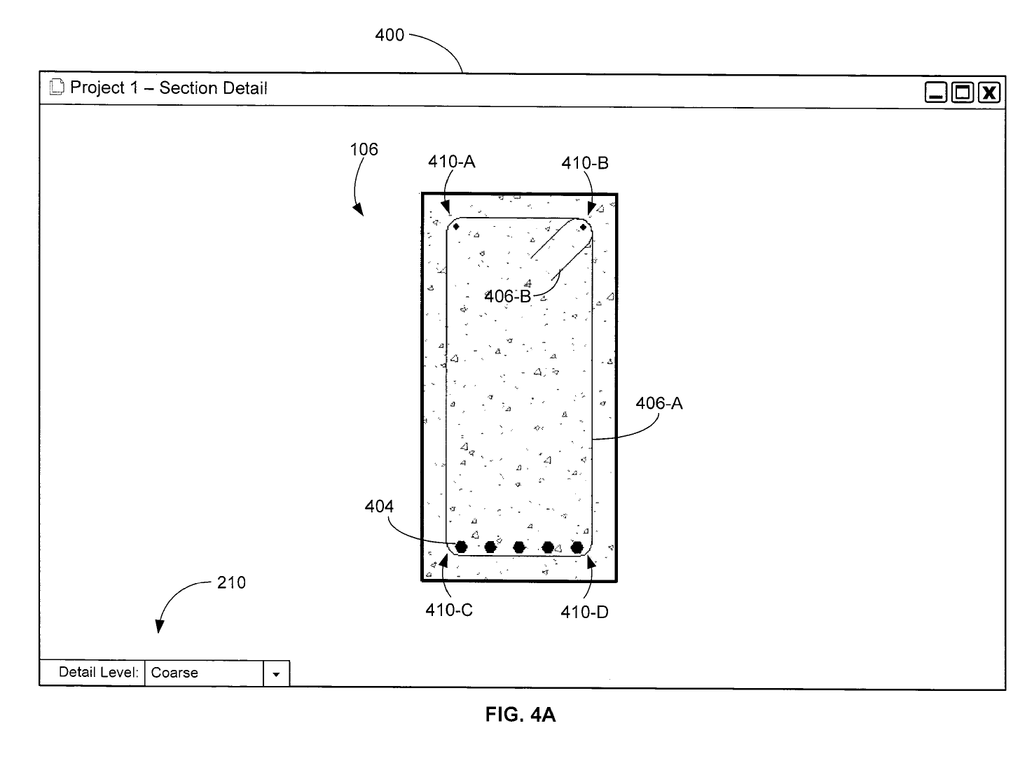

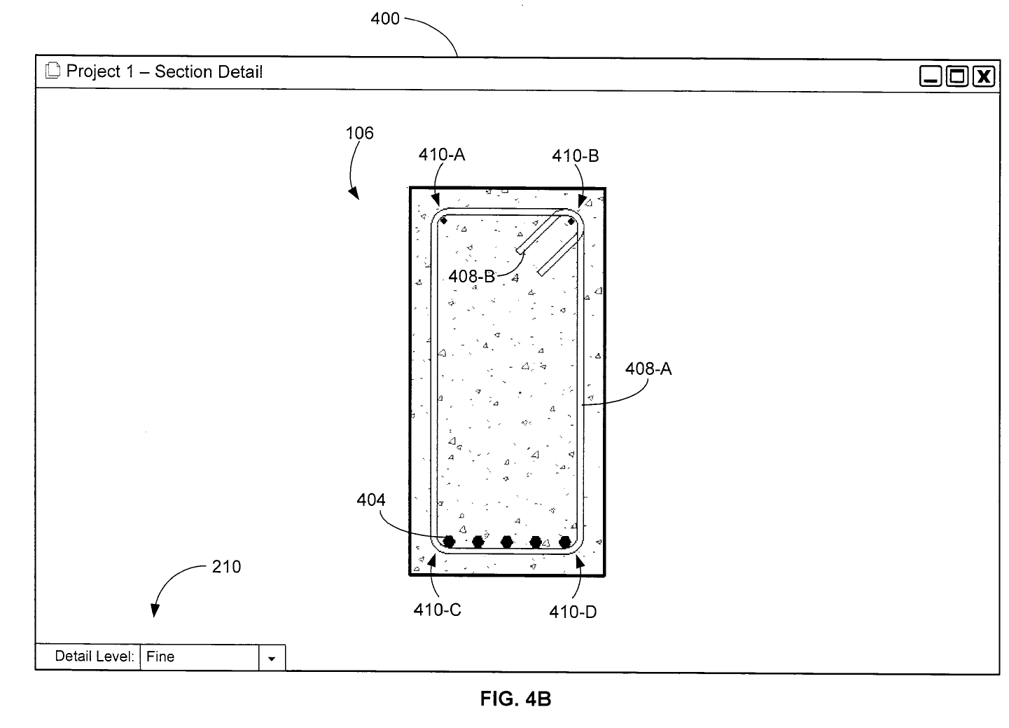

FIGS. 4A and 4B illustrate a section view 400 of beam object 106. The section view 400 shows a cross-section of the beam object 106 at an intersection of the beam with a cross-sectional plane. The section view 400 presents renderings of cross-sections of reinforcement elements 406-A and 406-B that intersect the cross-sectional plane. The reinforcement elements 406-A, 406-B run parallel to the cross-sectional plane and run orthogonal to the direction of the view 400.

The section view 400 also includes other elements in the beam object 106. For example, the section view 400 includes a reinforcement element 404 that runs parallel to the direction of the view 400.

The reinforcement elements 406-A and 406-B can be presented as views of reinforcement element ribbons 408-A, 408-B, respectively. In some implementations, the reinforcement elements 406-A, 406-B are rendered as ribbons 408-A, 408-B, respectively, when a detail level option 210 is changed to “fine” or an otherwise relatively high detail level. The ribbons 408-A, 408-B has respective widths that are equal to the respective width values of reinforcement elements 406-A, 406-B, respectively. The axes of the ribbons 408-A, 408-B are aligned with the axes of the reinforcement elements 406-A and 406-B, respectively.

In FIGS. 4A and 4B, reinforcement element 406-A and corresponding ribbon 408-A has a round-cornered rectangular configuration, with rounded corners 410-A, 410-B, 410-C, and 410-D. Reinforcement element 406-B and corresponding ribbon 408-B has a horseshoe configuration.

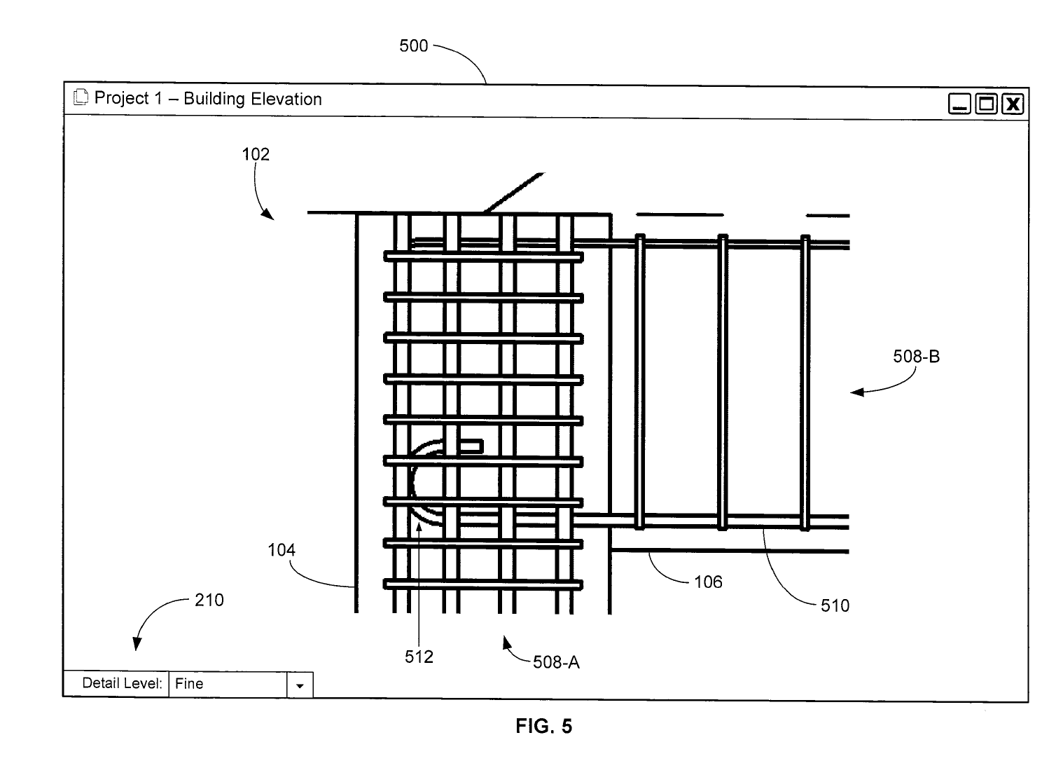

FIG. 5 illustrates an elevation view 500 of a portion of the structure 102. The elevation view 500 presents the beam object 106 framed into the column object 104. The elevation view 500 can present objects in the interior of the structure 102, the beam object 106, and/or the column object 104. For example, elevation view 500 presents projections of reinforcement elements 108-A, 108-B (FIG. 1) onto a viewing plane. The reinforcement elements are rendered as reinforcement element ribbons 508-A and 508-B (e.g., ribbon 510), and the ribbons are projected onto the viewing plane of the elevation view 500. The width of each individual “strip” of reinforcement element ribbon is the width value of the corresponding reinforcement element. The axis of each strip of reinforcement element ribbon is aligned with the axis of the respective corresponding reinforcement element.

In some implementations, the rendering and the presentation of the reinforcement element ribbons 508-A, 508-B is performed when a detail level option 210 for the elevation view 500 is set to “fine” or an otherwise relatively high detail level.

In some implementations, reinforcement element ribbons (or projections thereof) can obscure other objects in a view and can be obscured by other objects in the view. For example, in elevation view 500, the reinforcement element ribbon projections that are nearer to the foreground can obscure those ribbon projections that are further in the background. For example, portions of ribbon 510 (which has a configuration of a straight line with a hook), including portions of the hook 512 at one end of the ribbon 510, is obscured by ribbons 508-A.

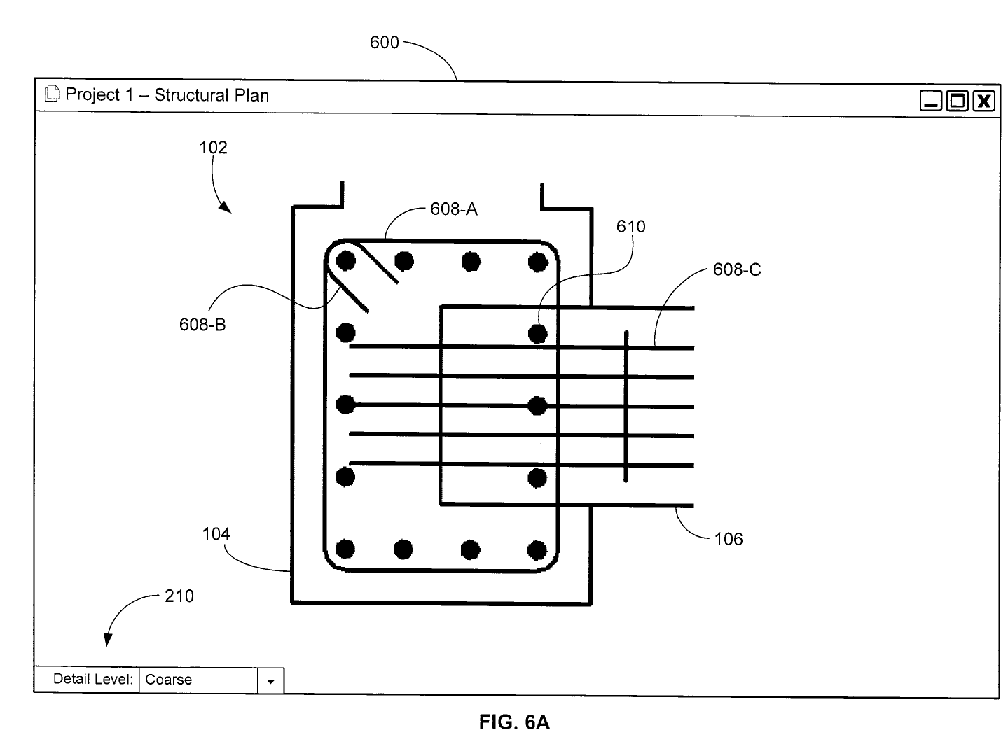

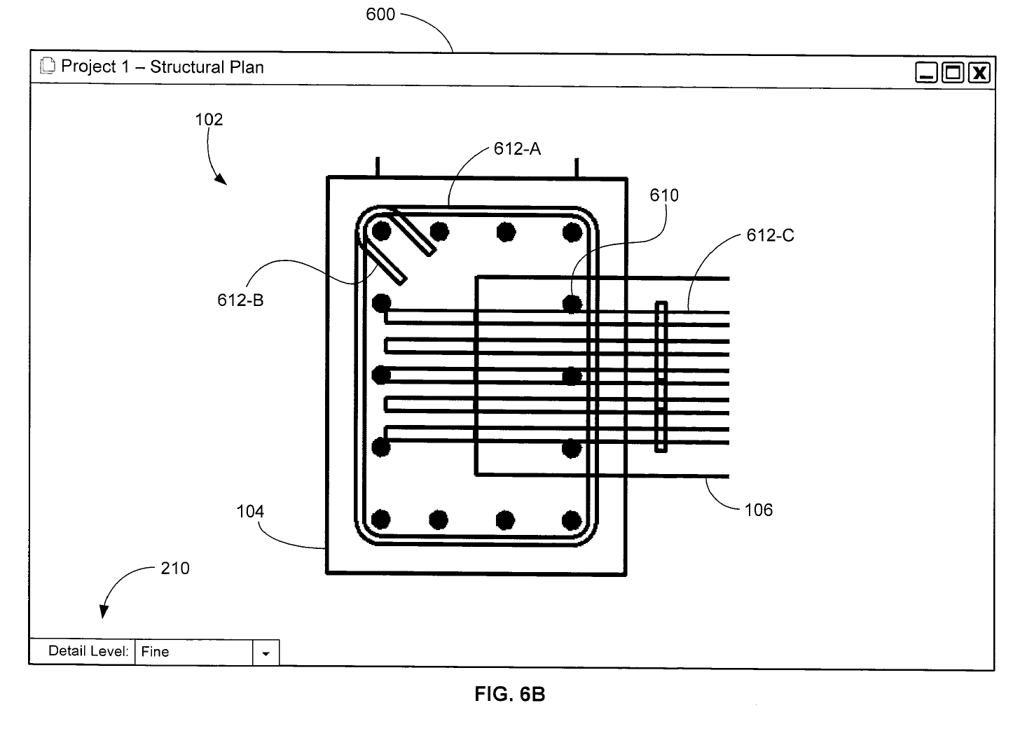

FIGS. 6A and 6B illustrate a structural plan view 600 of a portion of the structure 102. The plan view 600 shows a portion of the structure 102 where the beam object 106 is framed into the column object 104. The plan view 600 can present objects within the structure 102, including reinforcement elements, for example. For example, the plan view 600 includes projections or cross-sectional renderings of reinforcement elements 608-A, 608-B, and 608-C that run orthogonal to the direction of the view and of reinforcement element 610 that run parallel to the direction of the view. In some implementations, the plan view 600 also includes a detail level option 210. The reinforcement elements 608-A, 608-B, 608-C are presented as lines when the detail level option 210 is set to “coarse” or an otherwise relatively low detail level.

When the detail level option 210 is changed to “fine” or an otherwise relatively high detail level, the reinforcement elements 608-A, 608-B, and 608-C are rendered as ribbons and views of the ribbons 612-A, 612-B, and 612-C are presented. The ribbons have widths equal to the width values of their corresponding respective reinforcement elements.

By rendering the reinforcement elements as ribbons having widths and displaying the widths in the visual presentation of the reinforcement elements, potential interference between reinforcement elements and other objects in a structure can be detected by visual inspection. For example, in the plan view 600, reinforcement element ribbon cross-section 612-C is shown to overlap with reinforcement element 610. This indicates a potential interference issue that a user may resolve by moving either reinforcement element, for example.

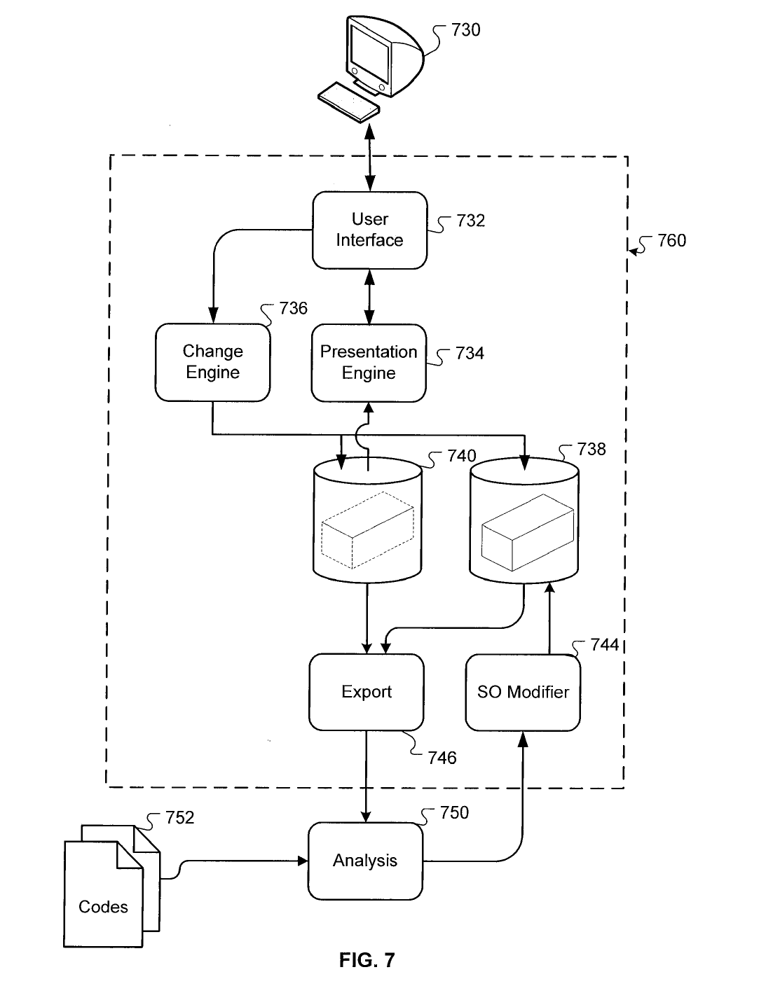

FIG. 7 is a block diagram of an example system as might be implemented by a CAD tool. Users can interact with the system 760 through one or more input/output devices 730 such as a keyboard, a display, a mouse, a speaker, a digital camera, a microphone, or other suitable devices. A user interface component 732 can accept user input from, and provide output to, the input/output devices 730. For example, the user interface component 732 can interact with users through a graphical user interface (GUI) that utilizes a display device 730.

Views of one or more solid objects 738, including any reinforcement elements, and one or more associated analytical representations of the solid objects 740 can be generated by the presentation engine component 734 and provided to the user interface component 732 for presentation on a display 730. The presentation engine component 734 can provide views in response to requests from the user interface component 732. The user interface component 732 can in turn present the views to users through the GUI, for example. Solid objects 738 and analytical representations 740 can be persisted in data structures or objects in memory, one or more files, one or more databases, or other persistent or non persistent storage, and combinations of these.

The user interface component 732 can accept user input from the devices 730 (e.g., by invoking GUI functions) and provide such to the change engine component 736. The change engine component 736 is responsible for propagating changes made to solid objects or analytical elements, for example, through user interaction with a view, to the affected solid objects 738 and analytical representations 740. For example, a user may change the location of a wall in a view of a CAD model. As another example, the user can create one or more reinforcement elements and add them to the CAD model. The corresponding solid object's location property will be updated to reflect the change, as well as any corresponding analytical representation (if any). The presentation engine component 734 reacts to updates by causing any views which are affected by the updates to be regenerated by the presentation engine 734 and provided to the user interface component 732.

The presentation engine 734 can render reinforcement elements in the solid objects 738 as ribbons. The presentation engine 734 renders and presents the reinforcement elements as ribbons when the view of the solid objects 738 to be provided to the user interface component 732 is one where the reinforcement elements can be rendered as ribbons. For example, if the view is a two-dimensional view (e.g., section view, elevation view, or a plan view), for which the detail level option is set to fine, then the presentation engine 734 renders reinforcement elements in the view as ribbons.

In some implementations, information describing solid objects 738, including any reinforcement elements, analytical elements 740, or combinations of these, can be provided by an export component 746 to one or more analysis applications 750 which can perform a structural analysis on behalf of the system 760 Various structural analysis programs can be used, and assorted types of analysis can be performed, including concrete design analysis, lateral load analysis, gravity load analysis, beam design analysis, steel design analysis, dynamic analysis, seismic analysis and steel connection design analysis.

In some implementations, the export component 746 can exchange information with analysis applications 750 using the Green Building XML (gbXML) document format. In further implementations, the information provided to an analysis program 750 can include an analytical representation (e.g., the analytical elements 740) of the solid objects 738. The analytical elements can include or be associated with properties, for example: geometry and location of analytical elements, moments of inertia, sheer capacity, connectivity or end conditions (e.g., pinned, fixed, free), material properties, reference to one or more corresponding solid objects, and release conditions. The analytical representation can also include any applicable construction codes 752 that could be used to guide the analysis and results generated there from.

The analytical representation can be subjected to load simulation and the like in a analysis program 750, for example, to identify stress levels in the various elements. The analysis application 750 can perform a stress analysis and the result of the stress analysis can determine how much reinforcement is required in a given solid object. For example, the analysis application 750 can determine that number four concrete reinforcement bars (0.668 pound per foot and 0.500 inch diameter) at a spacing of six inches apart are required (i.e., three inches of reinforcement per square foot) for a given floor slab. The analysis application 750 may need the forces in order to be able to size and space reinforcement structures it deems appropriate.

The results of the analysis can then imported into the system 760. On the basis of the analysis, solid objects may be modified (e.g., resized or other properties changed) by the solid object modifier component 744. As the CAD model evolves, users can iterate doing analysis and automatically importing the changes from analysis to the system 760.

In some implementations, solid objects 738, without any associated reinforcement elements, and the corresponding analytical elements 740, may be exported by the export component 746 to one or more analysis applications 750. The analysis applications 750 performs the analyses as described above and determines an arrangement of reinforcement elements to be added to the solid objects, including the number of reinforcement elements to be added, the types of reinforcement elements, and the layout of the reinforcement elements. The arrangement can then imported into the system 760. Reinforcement elements can be added to the solid objects may be modified (e.g., resized or other properties changed) by the solid object modifier component 744 in accordance with the imported arrangement.

It should be noted that all components that are illustrated can be executed on the same computing device, on different computing devices connected by one or more networks, and can include more components or fewer components than illustrated.

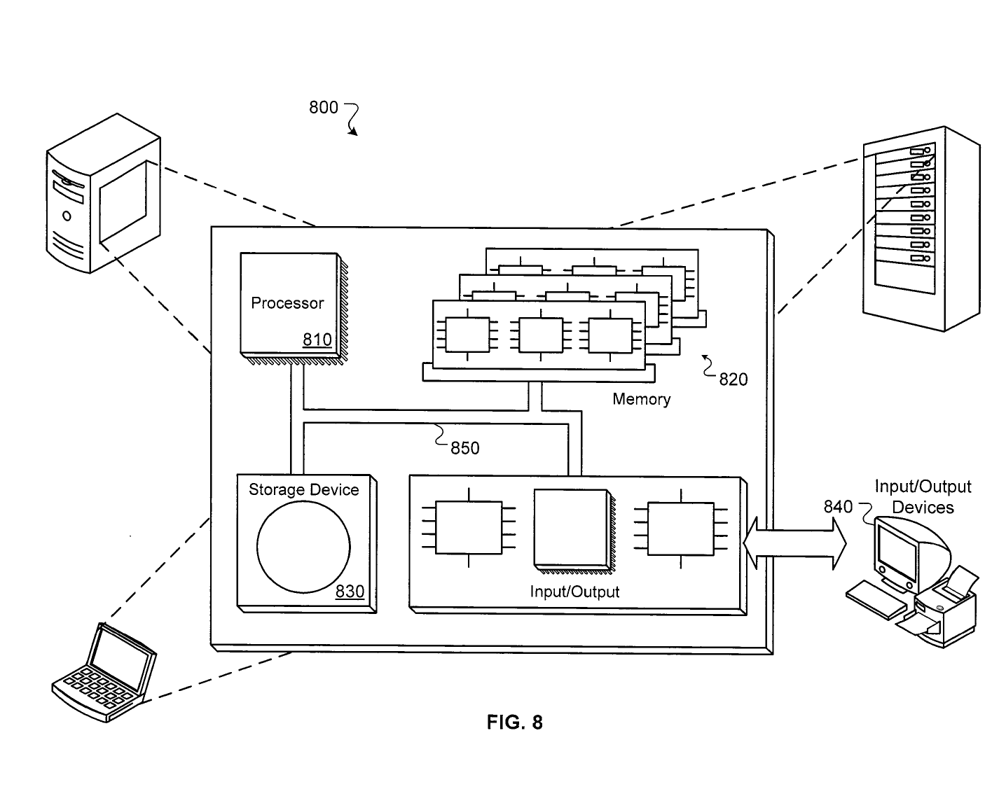

FIG. 8 is a schematic diagram of a generic computer system 800. The system 800 can be used for practicing operations described in association with process 300. The system 800 can include a processor 810, a memory 820, a storage device 830, and input/output devices 840. Each of the components 810, 820, 830, and 840 are interconnected using a system bus 850. The processor 810 is capable of processing instructions for execution within the system 800. Such executed instructions can implement one or more components of system 700, for example. In one implementation, the processor 810 is a single or multi-threaded processor having one or more processor cores. The processor 810 is capable of processing instructions stored in the memory 820 or on the storage device 830 to display graphical information for a user interface on the input/output device 840.

The memory 820 is a computer readable medium such as volatile or non volatile random access memory that stores information within the system 800. The memory 820 could store data structures representing solid objects 738 and analytical representations 740, for example. The storage device 830 is capable of providing persistent storage for the system 800. The storage device 830 may be a floppy disk device, a hard disk device, an optical disk device, or a tape device, or other suitable persistent storage means. The input/output device 840 provides input/output operations for the system 800. In one implementation, the input/output device 840 includes a keyboard and/or pointing device. In another implementation, the input/output device 840 includes a display unit for displaying graphical user interfaces.

The input/output device 840 can provide input/output operations for a CAD system. The CAD system can be, for example, Autodesk® Revit® Structure, available from Autodesk, Inc. of San Rafael, Calif., or another CAD application or other software application. The CAD system can include computer software components that manage reinforcement elements. Examples of such software components include the user interface 732, change engine 736, presentation engine 734, export component 746, and the solid object modifier 744. Such software components can be persisted in storage device 830, memory 820 or can be obtained over a network connection, to name a few examples.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of data processing apparatus. The computer-readable medium can be a machine-readable storage device, a machine-readable storage substrate, a memory device, a composition of matter effecting a machine-readable propagated signal, or a combination of one or more them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A computer-implemented method, comprising:
identifying a three-dimensional (3D) solid object in a computer aided design (CAD) model, the solid object having a volume;
associating a reinforcement element with the solid object, the reinforcement element defining a path within the volume and occupying no space in the volume, the reinforcement element having a width value greater than zero;
rendering the reinforcement element as a ribbon having a width and having no volume, wherein the width of the ribbon is the width value of the reinforcement element; and
presenting a view of the solid object, including a view of the ribbon, wherein the width of the ribbon is orthogonal to a direction of the view of the solid object.

2. The method of claim 1, wherein:
the reinforcement element is substantially cylindrical; and
the width value of the reinforcement element is a diameter value of the reinforcement element.

3. The method of claim 1, wherein:
the solid object is a complex solid object.

4. The method of claim 1, wherein:
the view of the solid object is a two-dimensional (2D) view of the solid object.

5. The method of claim 4, wherein:
the view of the solid object is a section view, an elevation view or a plan view.

6. The method of claim 1, further comprising:
accepting user input to cause creation of the reinforcement element.

7. The method of claim 1, wherein:
the reinforcement element is represented as a 3D line in the CAD model.

8. The method of claim 1, wherein:
the solid object is one of: a wall, a floor slab, a column, and a beam.

9. The method of claim 1, wherein:
an axis of the ribbon is aligned with an axis of the reinforcement element.

10. The method of claim 1, wherein:
the ribbon traces at least a portion of the path defined by the reinforcement element.

11. A computer program product, encoded on a computer-readable medium, operable to cause data processing apparatus to perform operations comprising:
identifying a three-dimensional (3D) solid object in a computer aided design (CAD) model, the solid object having a volume;
associating a reinforcement element with the solid object, the reinforcement element defining a path within the volume and occupying no space in the volume, the reinforcement element having a width value greater than zero;
rendering the reinforcement element as a ribbon having a width and having no volume, wherein the width of the ribbon is the width value of the reinforcement element; and
presenting a view of the solid object, including a view of the ribbon, wherein the width of the ribbon is orthogonal to a direction of the view of the solid object.

12. The computer program product of claim 11, wherein:
the reinforcement element is substantially cylindrical; and
the width value of the reinforcement element is a diameter value of the reinforcement element.

13. The computer program product of claim 11, wherein:
the solid object is a complex solid object.

14. The computer program product of claim 11, wherein:
the view of the solid object is a two-dimensional (2D) view of the solid object.

15. The computer program product of claim 14, wherein:
the view of the solid object is a section view, an elevation view or a plan view.

16. The computer program product of claim 11, further comprising:
accepting user input to cause creation of the reinforcement element.

17. The computer program product of claim 11, wherein:
the reinforcement element is represented as a 3D line in the CAD model.

18. The computer program product of claim 11, wherein:
the solid object is one of: a wall, a floor slab, column, and a beam.

19. The computer program product of claim 11, wherein:
an axis of the ribbon is aligned with an axis of the reinforcement element.

20. The computer program product of claim 11, wherein:
the ribbon traces at least a portion of the path defined by the reinforcement element.

21. A system, comprising:
means for identifying a three-dimensional (3D) solid object in a computer aided design (CAD) model, the solid object having a volume;
means for associating a reinforcement element with the solid object, the reinforcement element defining a path within the volume and occupying no space in the volume, the reinforcement element having a width value greater than zero;
means for rendering the reinforcement element as a ribbon having a width and having no volume, wherein the width of the ribbon is the width value of the reinforcement element; and
means for presenting a view of the solid object, including a view of the ribbon, wherein the width of the ribbon is orthogonal to a direction of the view of the solid object.

22. A system, comprising:
a display device;
memory; and
one or more processors; and
instructions stored in the memory, which when executed by the one or more processors, cause the one or more processor to perform operations comprising:
identifying a three-dimensional (3D) solid object in a computer aided design (CAD) model, the solid object having a volume;
associating a reinforcement element with the solid object, the reinforcement element defining a path within the volume and occupying no space in the volume, the reinforcement element having a width value greater than zero;
rendering the reinforcement element as a ribbon having a width and having no volume, wherein the width of the ribbon is the width value of the reinforcement element; and
presenting on the display device a view of the solid object, including a view of the ribbon, wherein the width of the ribbon is orthogonal to a direction of the view of the solid object.
